(19) United States
(12) Patent Application Publication
(10) Pub. No.: US 2008/0032694 A1
(43) Pub. Date: Feb. 7, 2008

(54) CELL RESELECTION APPARATUS AND METHOD IN MULTI MODE MOBILE TERMINAL

(75) Inventors: Hyun-Hye LEE, Suwon-si (KR); Sang-Hyun Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/833,575

(22) Filed: Aug. 3, 2007

(30) Foreign Application Priority Data
Aug. 3, 2006 (KR) 2006-0073187

(51) Int. Cl. H04Q 7/20

(52) U.S. Cl. 455/436

(57) ABSTRACT

Provided is a cell reselection apparatus and method in a multi mode mobile terminal supporting at least two network access schemes different from each other. The method includes calculating a cell reselection criterion value for each of a serving cell and neighbor cells; subtracting a predetermined value from the cell reselection criterion value for each of the neighbor cells and updating the cell reselection criterion values of the neighbor cells, when a current communication mode is an Unlicensed Mobile Access (UMA) mode; and determining whether to perform cell reselection, using the calculated cell reselection criterion value of the serving cell and the updated cell reselection criterion values of the neighbor cells.

### PRIORITY

This application claims priority under 35 U.S.C. § 119 to an application filed in the Korean Intellectual Property Office on Aug. 3, 2006 and assigned Ser. No. 2006-73187, the contents of which are incorporated herein by reference.

### BACKGROUND OF THE INVENTION

1. Field of the Invention

The present invention relates generally to a cellular network search apparatus and method in a multi mode mobile terminal, and in particular, to a cell reselection apparatus and method in a multi mode mobile terminal supporting Unlicensed Mobile Access (UMA).

2. Description of the Related Art

Unlicensed Mobile Access (UMA) technology refers to a next generation wired/wireless merging technology for connecting a Global System for Mobile communication/General Packet Radio Service (GSM/GPRS) mobile communication network with a Wireless Local Area Network (WLAN), using an unlicensed spectrum such as Bluetooth® (“Bluetooth”) and IEEE 802.11. By deploying the UMA technology, a UMA terminal can freely perform a voice and data communication crossing over wired and wireless networks.

One of the key features of the UMA terminal is to support rove-in/out and handover. Rove-in/out refers to a technology in which the UMA terminal accesses a UMA Network (UMAN) when it is in a wireless LAN area so that it can use a GSM voice and GPRS data service over the UMAN, and accesses a cellular network when it is out of the wireless LAN area so that it can use the service over the cellular network. Handover refers to a technology for supporting the UMA terminal so that a UMA terminal user can seamlessly use a GSM voice call over the UMAN, when entering the wireless LAN area out of a cellular network area as using the GSM voice call.

The cellular network will be described below on the basis of a GSM/GPRS network, which is an asynchronous mobile communication network, as an example.

Mobile terminals implementing a multi mode communication service over a GSM EDGE (Enhanced Data GSM Environment) Radio Access Network (GERAN), which is an access network of the cellular network, and a wireless LAN should support all of a GSM/GPRS protocol and a UMA protocol. In an Access Stratum (AS) module of the mobile terminal, a UMA Radio Resource (RR) entity and a GSM/GPRS RR entity operate in a dual mode, and only an entity in service can communicate with a Non-Access Stratum (NAS) module.

When the mobile terminal is in a UMA mode, the GSM/GPRS RR entity operates in two main modes: Hibernate Mode and Detached Cell Reselection Mode. These modes are described below.

1) Hibernate Mode

The GSM/GPRS RR entity turns off a GSM/GPRS RF transceiving module the moment it is in the UMA mode. Here, the GSM/GPRS RR entity stores serving cell information, and performs GSM/GPRS cell reselection using the stored serving cell information when it is out of a hibernate mode.

2) Detached Cell Reselection Mode

The GSM/GPRS RR entity performs standardized GSM/GPRS cell selection/reselection defined in 3GPP TS 43.002, irrespective of the UMA mode. However, it does not inform the NAS module of a change or non-change of the serving cell and its related information.

The systems of the related art have a drawback in that the GSM/GPRS cell reselection induces a great current consumption despite having no great influence on a service currently provided to the mobile terminal, if the GSM/GPRS RR entity operates in a detached cell reselection mode when the mobile terminal is in the UMA mode.

In particular, cell reselection is performed despite there not existing any problem in providing a service from the serving cell, because C2/C32 parameters, i.e., path loss criterion parameter values of neighbor cells among cell reselection criterions specified in 3GPP TS 43.002, are great. However, the cell reselection criterions may cause frequent cell reselection, and the frequent cell reselection results in unnecessary battery consumption despite having no great influence on service delivery to the mobile terminal operating in the UMA mode.

### SUMMARY OF THE INVENTION

An aspect of the present invention is to substantially solve at least the above problems and/or disadvantages and to provide at least the advantages below. Accordingly, an aspect of the present invention is to provide an apparatus and method for cell reselection when a multi mode mobile terminal supporting UMA operates in a UMA mode.

Another aspect of the present invention is to provide an apparatus and method for preventing frequent cell reselection when a multi mode mobile terminal supporting UMA operates in a UMA mode.

A further aspect of the present invention is to provide an apparatus and method for reducing battery consumption caused by cell reselection when a multi mode mobile terminal supporting UMA operates in a UMA mode.

According to one aspect of the present invention, there is provided a cell reselection method in a multi mode mobile terminal supporting at least two network accesses different from each other. The method includes calculating a cell reselection criterion value for each of a serving cell and neighbor cells; subtracting a predetermined value from the cell reselection criterion value for each of the neighbor cells and updating the cell reselection criterion values of the neighbor cells, when a current communication mode is an Unlicensed Mobile Access (UMA) mode; and determining whether to perform cell reselection, using the calculated cell reselection criterion value of the serving cell and the updated cell reselection criterion values of the neighbor cells.

According to another aspect of the present invention, there is provided a cell reselection apparatus in a multi mode mobile terminal supporting at least two network accesses different from each other. The apparatus includes a first communication unit for communicating with a cellular access network; a second communication unit for communicating with a UMA Network (UMAN); a controller for acquiring parameters required for calculating a cell reselection criterion value, from the first communication unit; and a cell reselection unit for calculating a cell reselection criterion value for each of a serving cell and neighbor cells, using the acquired parameters, and subtracting a predetermined value from the cell reselection criterion value for each of the neighbor cells and updating the cell reselection criterion values of the neighbor cells, when a current communication mode is a UMA mode.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the architecture of a network supporting UMA according to the present invention;

FIG. 2 is a block diagram illustrating the architecture of a multi mode terminal according to the present invention; and

FIG. 3 is a flowchart illustrating a cell reselection method in a multi mode mobile terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail. The terms described below, terms defined considering their functions in the present invention, can be different depending on a user or operator's intention or a practice. Thus, the definition should be made on the basis of the contents throughout this specification.

A technique for reducing battery consumption caused by cell reselection when a multi mode mobile terminal supporting cellular network access and Unlicensed Mobile Access (UMA) operates in a UMA mode will be described below.

The cellular network will be described on the basis of a Global System for Mobile communications/General Packet Radio Service (GSM/GPRS) network that is an asynchronous mobile communication network, as an example. However, the present invention is equally applicable to all networks interworking with the UMA, such as a synchronous mobile communication network (e.g., a Code Division Multiple Access (CDMA) network) as well as the asynchronous mobile communication network.

The UMA network will be described below on the basis of a merge solution of a mobile communication network and a Wireless Local Area Network (WLAN). However, UMA can be variously expanded by merging a cellular network with Internet Protocol (IP)-based wireless access networks, such as IEEE 802.16 networks (e.g., WiBro and WiMAX) and IEEE 802.20 Mobile Broadband Wireless Access (MBWA) and Ultra-WideBand (UWB) networks, without limiting the scope of the present intention.

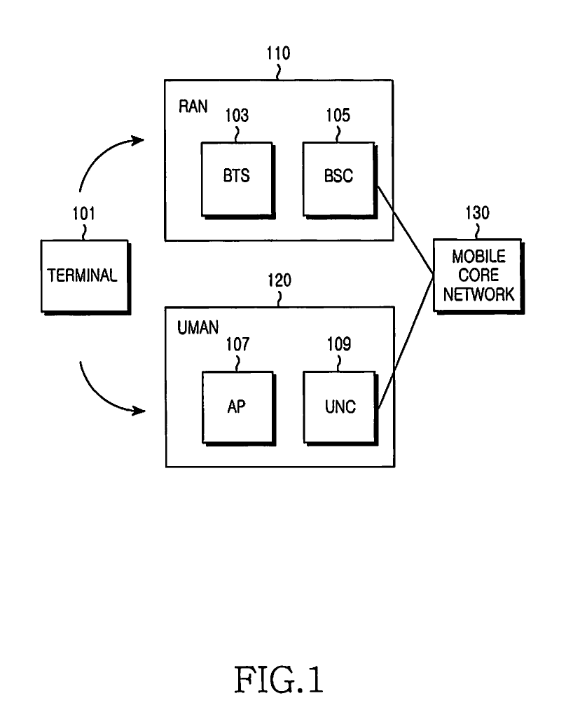

FIG. 1 illustrates the architecture of a network supporting UMA according to the present invention.

Referring to FIG. 1, a UMA Network (UMAN) 120 includes an Access Point (AP) 107, and a UMA Network Controller (UNC) 109.

The AP 107 provides Wireless Fidelity (Wi-Fi) or Bluetooth coverage, and a link to a broadband IP network for UMA solution. For example, the AP 107 may be part of a residential WLAN, an enterprise WLAN, or a public wireless hotspot.

The UNC 109 interfaces with a GSM/GPRS mobile core network 130 as if being a Base Station Subsystem (BSS) of a GSM/EDGE Radio Access Network (GERAN), and communicates with a terminal 101 with a UMA function. The UNC 109 provides the GSM/GPRS mobile core network 130 with a standard GSM A interface for circuit switched voice service and a GPRS Gb interface for packet data service. In other words, the UNC 109 makes an IP based UMA network 102 appear to be the GERAN in the GSM/GPRS core network 130.

A cellular Radio Access Network (RAN) 110 includes a Base Transceiver Station (BTS) 103 and a Base Station Controller (BSC) 105.

The BTS 103 communicates wirelessly with the terminal 101. The BSC 105 interfaces a signal between the BTS 103 and the GSM/GPRS mobile core network 130, and performs inter-cell handover processing and call control. Key architecture of the GSM/GPRS mobile core network 130 is a Mobile Switching Center (MSC) (not shown). The MSC implements call switching, mobility management, position registration/management, authentication, handover, and rove in/out.

The terminal 101 refers to a multi mode terminal supporting cellular network access and UMA. The terminal 101 accesses the mobile core network 130 via the UMAN 120 when in a wireless LAN area, and accesses the core network 130 via the RAN 110 when out of the wireless LAN area.

In the above-described network architecture, the terminal 101 implements cell reselection even when it accesses the UMAN 120 and is in service. The cell reselection of the terminal in the UMA mode according to the present invention will be described in detail.

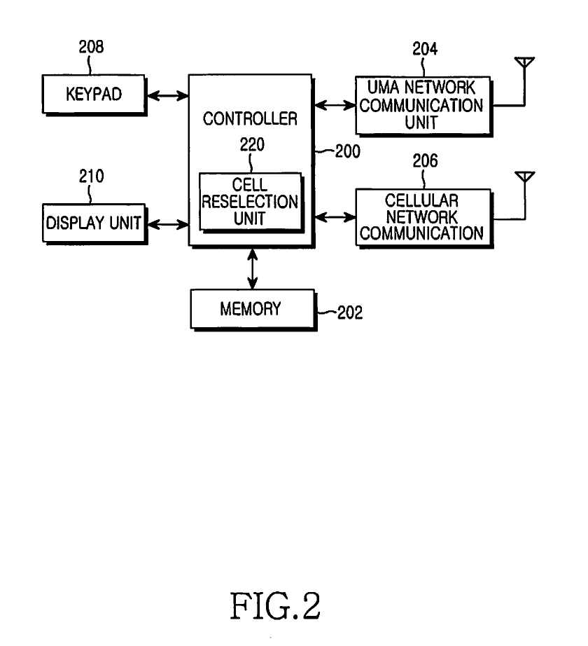

FIG. 2 is a block diagram illustrating the architecture of the multi mode terminal 101 according to the present invention.

As shown in FIG. 2, the multi mode terminal 101 includes a controller 200, a memory 202, a UMAN communication unit 204, a cellular network communication unit 206, a keypad 208, and a display unit 210. The controller 200 includes a cell reselection unit 220 according to the present invention.

Referring to FIG. 2, the controller 200 controls a general operation of the terminal 101. For example, the controller 200 processes and controls a voice call and data communication. The controller 200 controls cell reselection based on the UMA mode according to the present invention, in addition to a general function. It is assumed that the cell reselection unit 220 implements cell reselection according to the present invention.

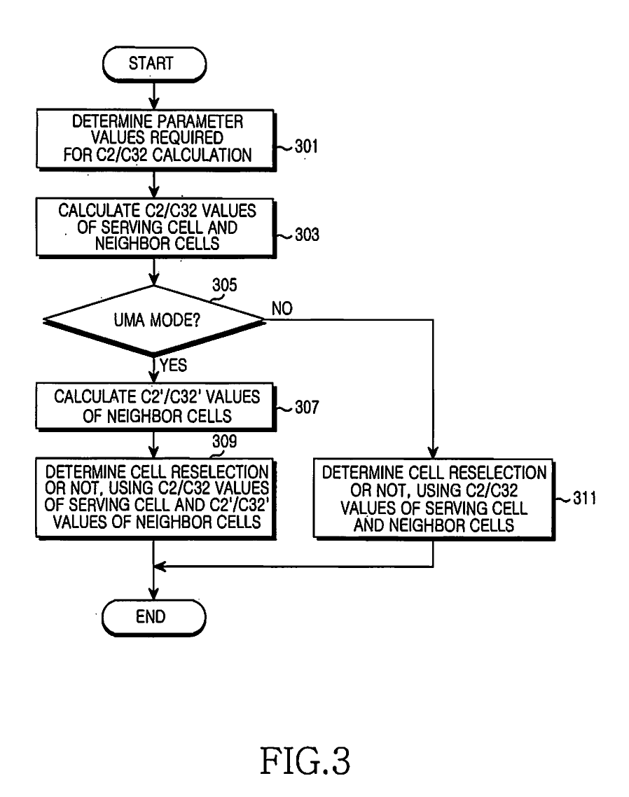

The cell reselection unit 220 calculates C2/C32 values for a serving cell and neighbor cells according to a standardized definition, and checks a current mode. When the current mode is the UMA mode, the cell reselection unit 220 subtracts a predetermined value (UMA_CELL_RESELECTION_HYSTERESIS) from the C2/C32 values of the neighbor cells, thereby updating the C2/C32 values of the neighbor cells. The updated C2/C32 values are defined as C2′/C32′ values in the present invention. In the UMA mode, the cell reselection unit 220 determines whether to perform the cell reselection, using the C2/C32 value of the serving cell and the C2′/C32′ values of the neighbor cells. In the UMA mode, the cell reselection unit 220 reduces the C2/C32 values of the neighbor cells, thereby preventing a frequent cell reselection in advance. This will be described in detail with reference to FIG. 3 below.

The memory 202 includes a program memory, a data memory, and a nonvolatile memory. The memory 202 stores programs for controlling a general operation of the terminal, temporary data generated in terminal operation, a system parameter, and other storage data (e.g., telephone numbers and messages). According to the present invention, the memory 202 stores each variety of parameter values required for cell reselection determination. Part of the parameter values are acquired from system information received from a cell, and other parts are measured in the terminal 101.

The UMAN network communication unit 204 represents a physical (PHY) interface module for accessing the UMAN 120. The cellular network communication unit 206 represents a physical interface module for accessing the cellular access network 110. The terminal 101 accesses the core network 130 via the UMAN communication unit 204 when being in the wireless LAN area, and accesses the mobile core network 130 via the cellular network communication unit 206 when being out of the wireless LAN area.

The keypad 208 includes a plurality of keys. The keypad 208 provides key input data corresponding to a key pressed by a user, to the controller 200. The display unit 210 displays state information (or an indicator) generated in terminal operation, user input characters, moving pictures, and still pictures. The display unit 210 can be a Liquid Crystal Display (LCD). The display unit 210 can also operate as an input device when the LCD is realized in a touch screen method.

FIG. 3 is a flowchart illustrating a cell reselection method in the multi mode mobile terminal according to the present invention.

Referring to FIG. 3, in Step 301, the cell reselection unit 220 determines the parameter values required for calculating the C2/C32 values. The parameter values will be described below.
CELL_RESELECT_OFFSET/GPRS_RESELECT_OFFSET
TEMPORARY OFFSET/GPRS_TEMPORARY_OFFSET
PENALTY_TIME/GPRS_PENALTY_TIME
RXLEV_ACCESS_MIN/GPRS_RXLEV_ACCESS_MIN
MS_TXPWR_MAX_CCH/GPRS_MS_TXPWR_MAX_CCH
PRIORITY_CLASS
PRIORITY_CLASS(s)

The parameter values refer to values acquired from system information of a corresponding cell. Each of the parameter values has been specified according to its meaning in the 3GPP TS 43.002 standard and thus, its detailed description will be omitted below.

The parameter values measured in the terminal 101 will be described below:
RLA_C: average value of reception signal level,
P: maximum RF output power value of terminal, and
T: timer value starting from when corresponding cell is placed in a strongest carrier list.

After determining all the parameter values in Step 301, the cell reselection unit 220 calculates the C2 value and the C32 value for each of the serving cell and the neighbor cells in Step 303 as shown in the Equation below:

C2=C1+CELL_RESELECT_OFFSET−TEMPORARY OFFSET*H(PENALTY_TIME−T) for PENALTY_TIME < >11111,

C2=C1−CELL_RESELECT_OFFSET for PENALTY_TIME=11111, and

C32=C1′+GPRS_RESELECT_OFFSET−TO*(1−L)

where,

H(x): function having “0” when x<0 and having “1” when x>0,

C1=(RLA_{—}C−RXLEV_ACCESS_MIN)−Max((MS_{—}TXPWR_MAX_{—}CCH−P),0),

C1′=(RLA_{—}C−GPRS_{—}RXLEV_ACCESS_MIN)−Max((GPRS_{—}MS_{—}TXPWR_MAX_{—}CCH−P),0),

TO=GPRS_TEMPORARY_OFFSET*H(GPRS_PENALTY−T), and

L=0 if PRIORITY_CLASS=PRIORITY_CLASS(s)

1 if PRIORITY_CLASS≠PRIORITY_CLASS(s).

In Step 305, the cell reselection unit 220 checks whether the current communication mode is the UMA mode, after calculating the C2 value and the C32 value for each of the serving cell and the neighbor cells. If the current communication mode is not the UMA mode, in Step 311, the cell reselection unit 220 determines whether to perform cell reselection, using the C2 value and the C32 value for each of the serving cell and the neighbor cells. For example, the cell reselection unit 220 can reselect the neighbor cell as the serving cell when the C2 value of the serving cell is smaller than the C2 value of the neighbor cell. In other words, it performs cell reselection when the serving cell has a smaller strength or a greater path loss in a reception signal than the neighbor cell.

When the current communication mode is the UMA mode, in Step 307, the cell reselection unit 220 calculates a C2′ value and a C32′ value for each of the neighbor cells as shown in the Equation below:

C2′=C2−UMA_CELL_RESELECTION_HYSTERESIS, and

C32′=C32−UMA_CELL_RESELECTION_HYSTERESIS

The UMA_CELL_RESELECTION_HYSTERESIS is a predetermined value that may be determined in proportion to a reception signal strength of a corresponding cell and may be equally applied to all cells. Alternatively, the UMA_CELL_RESELECTION_HYSTERESIS may be the system information broadcasted by the cell, or a value set to the terminal from the beginning.

In Step 309, the cell reselection unit 220 determines whether to perform cell reselection, using the C2/C32 values for the serving cell and the C2′/C32′ values for the neighbor cells, after calculating the C2′ value and the C32′ value for each of the neighbor cells. For example, it can reselect the neighbor cell as the serving cell when the C2 value of the serving cell is smaller than the C2′ value of the neighbor cell.

As described above, the present invention reduces the C2/C32 values of the neighbor cells when the terminal operates in the UMA mode, thereby preventing frequent cell reselection in advance.

The present invention has an effect in which the neighbor cell is given a predetermined handicap in calculating the C2/C32 values, which are the cell reselection criterion values, when the multi mode terminal operates in the UMA mode, to thereby prevent frequent cell reselection. In other words, the present invention is advantageous in reducing battery consumption (or current consumption) caused by frequent cell reselection.

Exemplary embodiments of the present invention can also comprise computer readable codes on a computer readable medium. The computer readable medium can comprise any data storage device that can store data that can be read by a computer system. Exemplary of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion. Also, functional programs, codes, and code segments for accomplishing exemplary embodiments of the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A cell reselection method in a multi mode mobile terminal supporting at least two different network access schemes, the method comprising:
calculating a cell reselection criterion value for each of a serving cell and neighbor cells;
subtracting a predetermined value from the cell reselection criterion value for each of the neighbor cells and updating the cell reselection criterion values of the neighbor cells, when a current communication mode is an Unlicensed Mobile Access (UMA) mode; and
determining whether to perform cell reselection, using the calculated cell reselection criterion value of the serving cell and the updated cell reselection criterion values of the neighbor cells.

2. The method of claim 1, wherein the cell reselection criterion value is at least one of C2 and C32, which are path loss criterion values used in an asynchronous cellular network.

3. The method of claim 1, wherein the mobile terminal supports asynchronous cellular network access and UMA.

4. The method of claim 1, wherein determining whether to perform cell reselection comprises:
comparing the calculated cell reselection criterion value of the serving cell with the updated cell reselection criterion values of the neighbor cells; and
performing cell reselection when the cell reselection criterion value of the serving cell is smaller than the cell reselection criterion values of the neighbor cells.

5. The method of claim 1, further comprising determining whether to perform cell reselection or not, using the calculated cell reselection criterion values of the serving cell and the neighbor cells, when the current communication mode is not the UMA mode.

6. The method of claim 1, wherein the cell reselection criterion value (C2) is calculated according to
C2=C1+CELL_RESELECT_OFFSET_TEMPORARY OFFSET*H(PENALTY_TIME−T) for PENALTY_TIME < >11111, and
C2=C1−CELL_RESELECT_OFFSET for PENALTY_TIME=11111
where,
C1=(RLA_{—}C−RXLEV_ACCESS_MIN)−Max((MS_{—}TXPWR_MAX_{—}CCH−P),0),
CELL_RESELECT_OFFSET, TEMPORARY OFFSET, PENALTY_TIME, RXLEV_ACCESS_MIN, and MS_TXPWR_MAX_CCH are system information broadcasted from cell,
RLA_C is an average value of reception signal level measured by terminal,
P is a maximum RF output power value of terminal,
T is a timer value starting from when corresponding cell is placed in a strongest carrier list, and
H(x) is a function having “0” when x<0 and having “1” when x>0.

7. The method of claim 1, wherein the cell reselection criterion value (C32) is calculated according to
C32=C1′+GPRS_RESELECT_OFFSET−TO*(1−L)
where,
C1′=(RLA_{—}C_{—}GPRS_{—}RXLEV_ACCESS_MIN)−Max((GPRS_{—}MS_{—}TXPWR_MAX_{—}CCH−P),0),
TO=GPRS_TEMPORARY_OFFSET*H(GPRS_PENALTY−T),
L=0 if PRIORITY_CLASS=PRIORITY_CLASS(s), L=1 if PRIORITY_CLASS≠PRIORITY_CLASS(s),
GPRS_RESELECT_OFFSET, GPRS_RXLEV_ACCESS_MIN, GPRS_MS_TXPWR_MAX_CCH, GPRS_TEMPORARY_OFFSET, GPRS_PENALTY, PRIORITY_CLASS, and PRIORITY_CLASS(s) are system information broadcasted from cell,
RLA_C is an average value of reception signal level measured by terminal,
P is a maximum RF output power value of terminal,
T is a timer value starting from when corresponding cell is placed in a strongest carrier list, and
H(x) is a function having “0” when x<0 and having “1” when x≧0.

8. A cell reselection apparatus in a multi mode mobile terminal supporting at least two different network access schemes, the apparatus comprising:
a first communication unit for communicating with a cellular access network;
a second communication unit for communicating with an Unlicensed Mobile Access (UMA) Network (UMAN);
a controller for acquiring parameters required for calculating a cell reselection criterion value, from the first communication unit; and
a cell reselection unit for calculating a cell reselection criterion value for each of a serving cell and neighbor cells, using the acquired parameters, and subtracting a predetermined value from the cell reselection criterion value for each of the neighbor cells and updating the cell reselection criterion values of the neighbor cells, when a current communication mode is a UMA mode.

9. The apparatus of claim 8, wherein the cell reselection criterion value is at least one of C2 and C32, which are path loss criterion values used in an asynchronous cellular network.

10. The apparatus of claim 8, wherein the cell reselection unit determines whether to perform cell reselection, using the calculated cell reselection criterion value of the serving cell and the updated cell reselection criterion values of the neighbor cells, when the current communication mode is the UMA mode.

11. The apparatus of claim 8, wherein the cell reselection unit determines whether to perform cell reselection, using the calculated cell reselection criterion values of the serving cell and the neighbor cells, when the current communication mode is not the UMA mode.

12. The apparatus of claim 8, wherein the cell reselection unit implements cell reselection when the cell reselection criterion value of the serving cell is smaller than the updated reselection criterion values of the neighbor cells.

13. The apparatus of claim 8, wherein the cell reselection unit calculates the cell reselection criterion value (C2) according to
C2=C1+CELL_RESELECT_OFFSET−TEMPORARY OFFSET*H(PENALTY_TIME−T) for PENALTY_TIME < >11111, and
C2=C1−CELL_RESELECT_OFFSET for PENALTY_TIME=11111
where,
C1=(RLA_{—}C−RXLEV_ACCESS_MIN)−Max((MS_{—}TXPWR_MAX_{—}CCH−P),0),
CELL_RESELECT_OFFSET, TEMPORARY OFFSET, PENALTY_TIME, RXLEV_ACCESS_MIN, and MS_TXPWR_MAX_CCH are system information broadcasted from cell,
RLA_C is an average value of reception signal level measured by terminal,
P is a maximum RF output power value of terminal,
T is a timer value starting from when corresponding cell is placed in a strongest carrier list, and
H(x) is a function having “0” when x<0 and having “1” when x>0.

14. The apparatus of claim 8, wherein the cell reselection unit calculates the cell reselection criterion value (C32) according to
C32=C1′+GPRS_RESELECT_OFFSET−TO*(1−L)
where,
C1′=(RLA_{—}C−GPRS_{—}RXLEV_ACCESS_MIN)−Max((GPRS_{—}MS_{—}TXPWR_MAX_{—}CCH−P),0),
TO=GPRS_TEMPORARY_OFFSET*H(GPRS_PENALTY−T),
L=0 if PRIORITY_CLASS=PRIORITY_CLASS(s), L=1 if PRIORITY_CLASS≠PRIORITY_CLASS(s),
GPRS_RESELECT_OFFSET, GPRS_RXLEV_ACCESS_MIN, GPRS_MS_TXPWR_MAX_CCH, GPRS_TEMPORARY_OFFSET, GPRS_PENALTY, PRIORITY_CLASS, and PRIORITY_CLASS(s) are system information broadcasted from cell,
RLA_C is an average value of reception signal level measured by terminal,
P is a maximum RF output power value of terminal,
T is a timer value starting from when corresponding cell is placed in strongest carrier list, and
H(x) is a function having “0” when x<0 and having “1” when x>0.

15. A mobile terminal supporting at least two different network access schemes, the mobile terminal comprising:
a first communication unit for communicating with a cellular access network;
a second communication unit for communicating with an Unlicensed Mobile Access (UMA) Network (UMAN);
a controller for acquiring parameters required for calculating a cell reselection criterion value, from the first communication unit; and
a cell reselection unit for calculating a cell reselection criterion value for each of a serving cell and neighbor cells, using the acquired parameters, and subtracting a predetermined value from the cell reselection criterion value for each of the neighbor cells and updating the cell reselection criterion values of the neighbor cells, when a current communication mode is a UMA mode.

16. The mobile terminal of claim 15, wherein the cell reselection criterion value is at least one of C2 and C32, which are path loss criterion values used in an asynchronous cellular network.

17. The mobile terminal of claim 15, wherein the mobile terminal supports CSM/GPRS (Global System for Mobile communications/General Packet Radio Service) network access and the UMA.

18. A computer-readable recording medium having recorded thereon a program for cell research in a mobile terminal supporting at least two different network access schemes, comprising:
a first code segment, for causing a computing device to calculate a cell reselection criterion value for each of a serving cell and neighbor cells;
a second code segment, for causing a computing devices to subtract a predetermined value from the cell reselection criterion value for each of the neighbor cells and update the cell reselection criterion values of the neighbor cells, when a current communication mode is an Unlicensed Mobile Access (UMA) mode;
a third code segment, for causing a computing device to determine whether to perform cell reselection, using the calculated cell reselection criterion values of the neighbor cells.

19. The computer-readable recording medium of claim 18, wherein the cell reselection criterion value is at least one of C2 and C32, which are path loss criterion values used in an asynchronous cellular network.

20. The computer-readable recording medium of claim 18, wherein the mobile terminal supports CSM/GPRS (Global System for Mobile communications/General Packet Radio Service) network access and the UMA.
